(19) United States
(12) Patent Application Publication
(10) Pub. No.: US 2025/0238680 A1
(43) Pub. Date: Jul. 24, 2025

(54) METHOD FOR TRAINING A MACHINE LEARNING MODEL INTO A TASK-SPECIFIC MODEL

(71) Applicant: SR AI INC, MONTREAL (CA)

(72) Inventors: Oleksandr SOKOLOV, TORONTO (CA); Paul DAIGLE, MONTREAL (CA)

(73) Assignee: SR AI Inc, MONTREAL, QC (CA)

(21) Appl. No.: 19/034,697

(22) Filed: Jan. 23, 2025

Related U.S. Application Data
(60) Provisional application No. 63/624,344, filed on Jan. 24, 2024.

(51) Int. Cl. G06N 3/091

(52) U.S. Cl. CPC G06N 3/091

(57) ABSTRACT

The present specification provides a method for training a machine learning model into a task-specific model. The method comprises steps of prompting a Large Language Model (LLM) to generate definitions and manifestations and a test data set for information elements related to a task. The method comprises inputting the list of information elements, the definitions and the manifestations in the machine learning model as structured learning parameters and label by the machine learning model an initial data set to generate a labelled data set. The method performs an adversarial augmentation loop on the labelled data set, the adversarial augmentation loop: identifying improper embeddings in the labelled data set, re-labelling the improper labels in the labelled data set and generating a task-specific data set. The method evaluates performance of the machine learning model trained with the task-specific data set by instructing the machine learning model to classify the test data set.

### TECHNICAL FIELD

The present disclosure relates generally to a method for training a machine learning model, and more specifically to a method for training a machine learning model into a task-specific model.

### BACKGROUND

Large Language Models are computationally expensive. To reduce computational costs, smaller models are often preferred. Smaller models require training to be functional and efficient. More particularly, smaller models require targeted training for the subject on which they are to become functional and efficient. Smaller models have also been proven to be better at handling narrower tasks than LLMs, when properly trained.

Properly training a smaller model is however time and skill demanding. Typically, training a smaller model includes collecting and preparing data, perform iterative training of the smaller model, evaluate the training progress of the smaller model, tune parameters of the smaller model to improve performance, and make predictions by the smaller model using test data set. Training smaller models thus requires collaboration between specialized software developers and skilled people in the field of training of the smaller model.

There is therefore a need for simplifying and automating training of a machine learning model. More particularly, there is a need for leveraging LLM capabilities for training a machine learning model into a task-specific model.

### SUMMARY

According to a first aspect, there is disclosed a method for training a machine learning model into a task-specific model. The method comprises receiving, by a computer, a list of information elements relating to a task. The method also comprises prompting, by the computer, a Large Language Model (LLM), to generate definitions and manifestations for the information elements in the context of the task. The method further comprises prompting, by the computer, the LLM to generate a test data set for the information elements, the definitions, and the manifestations in the context of the task. The method comprises inputting, by the computer, the task, the list of information elements, the definitions, and the manifestations in the machine learning model as structured learning parameters. The method labels an initial data set using the structured learning parameters. The method further performs, by the computer, an adversarial augmentation loop on the labelled data set, the adversarial augmentation loop: identifying improperly labelled data in the labelled data set, re-labelling the improperly labelled data, and generating a task-specific data set. The method also evaluates, by the computer, performance of the machine learning model by instructing the machine learning model to classify the test data set, and if results of the classifying by the machine learning model of the test data set is above a threshold, the training of the machine learning model into the task-specific model is completed.

### BRIEF DESCRIPTION OF THE DRAWINGS

Embodiments of the disclosure will be described by way of example only with reference to the accompanying drawings, in which:

FIG. 1 illustrates an overview of the present method;

FIG. 2 illustrates steps of the method for performing the labeling 120 of FIG. 1;

FIG. 3 illustrates steps of the method for performing the semantic search augmentation 130 of FIG. 1;

FIG. 4 illustrates steps of the method for performing the adversarial augmentation loop 140 of FIG. 1;

FIG. 5 illustrates steps of the method for performing the false hit correction loop 140a of FIG. 4;

FIG. 6 illustrates steps of the method for performing the themes generation 140c of FIG. 4; and

FIG. 7 is a functional diagram illustrating exemplary hardware components for performing the present method.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

The following terminology is used throughout the present disclosure:
Data set: collection of sentences or paragraphs that make up a semantically cohesive unit.
Embedding: semantic representation of a word, a sentence, a paragraph, or a document, in a space of N dimensions.
Entity: Physical person, legally defined organization, or concept.
Information element: any one of the following type of information: a topic, an entity, a sentiment, or any other type of information element pertaining to a task.
Initial data set: structured data to be labelled by the present method.
“in the context of”: used in the present specification in opposition to ‘out of context’.
Machine learning model: computer algorithm for analyzing patterns, making predictions or decisions for input data.
Task-specific model: machine learning model trained by a task-specific data set and directed at performing a specific task.
Task: Activity performed by a model (for example an analysis or pattern interpretation) using data (for example structured data) in a field of interest or in relation to a topic, subject, etc.

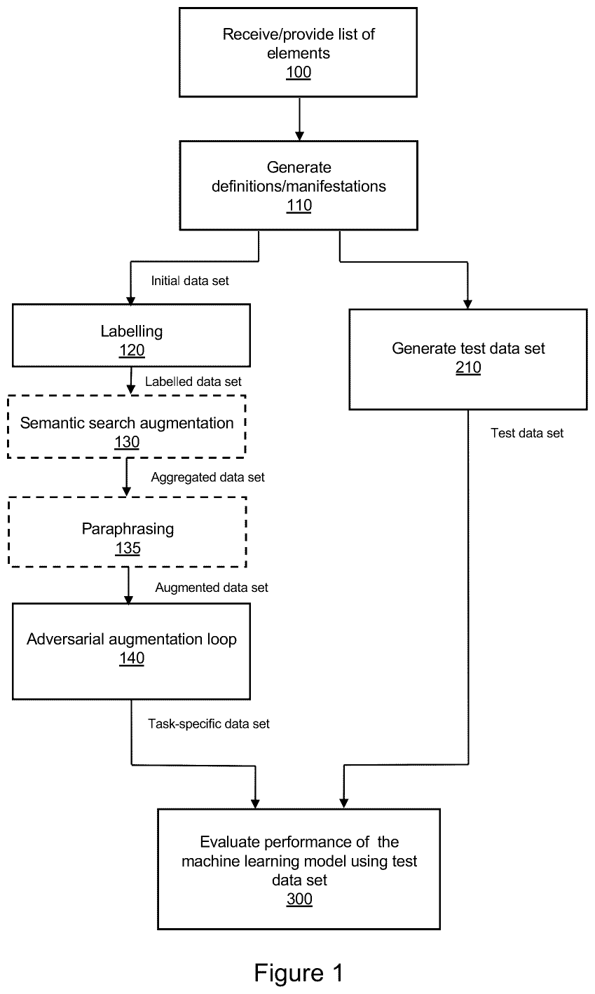

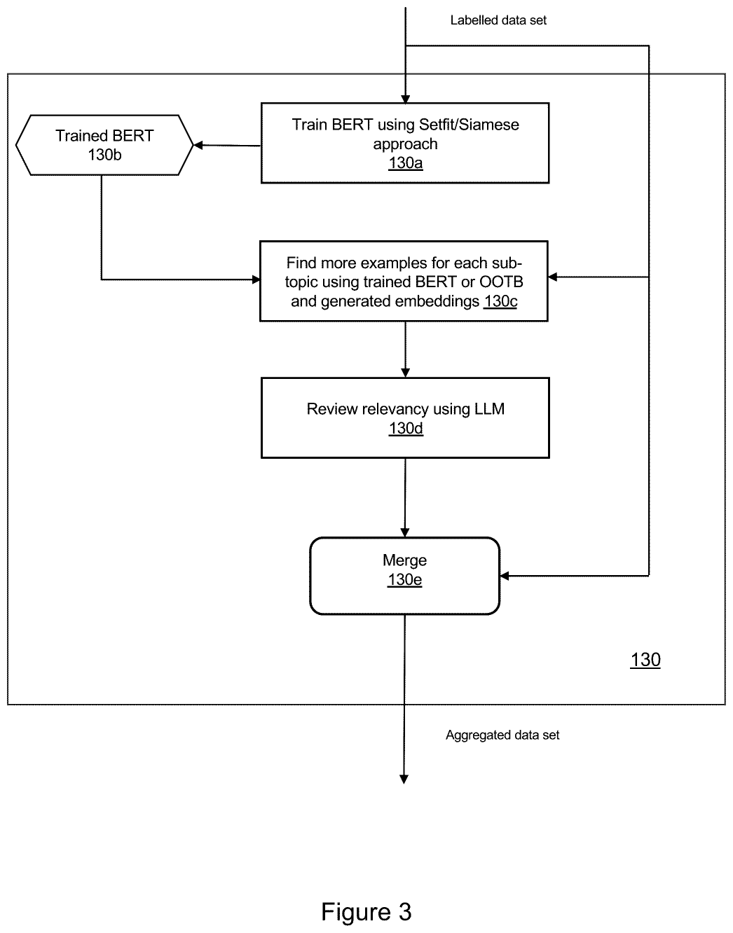

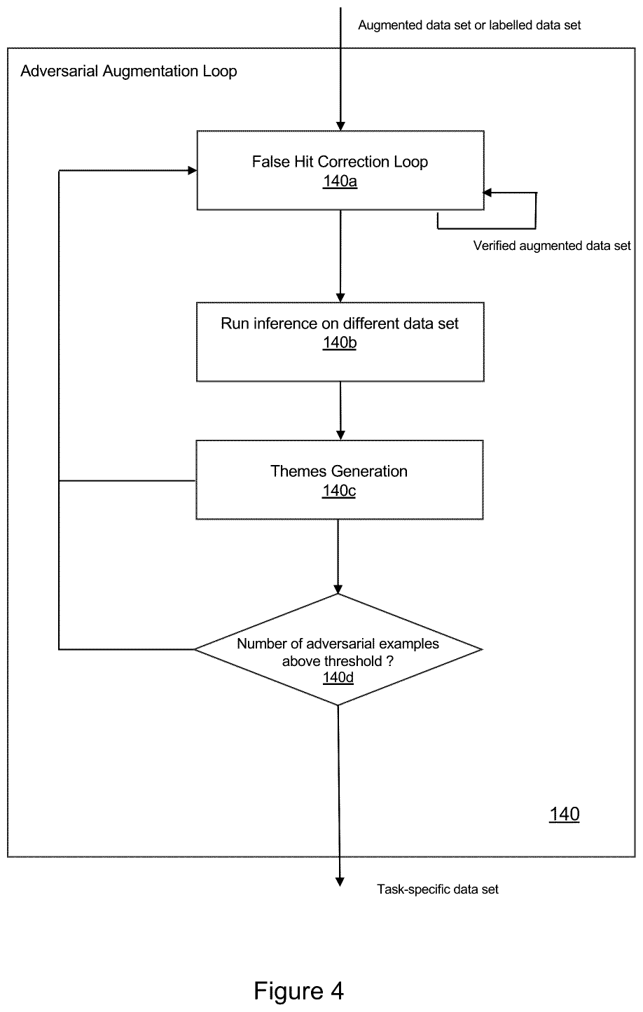

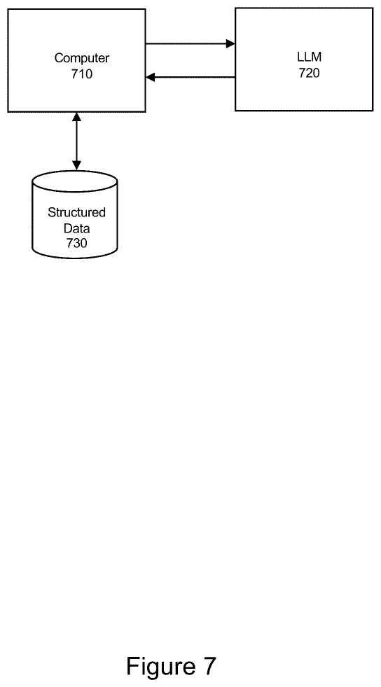

Referring now concurrently to FIGS. 1-7, there is depicted a method for training a machine learning model into a task-specific model, using a Large Language Model (LLM). The method further automatically evaluates the training progress of the machine learning model for the particular task. Focusing training of the machine learning model on a particular task provides several advantages. By focusing the training of the machine learning model on a particular task, it is possible to identify and address labeling inaccuracies, and more efficiently, e.g. rapidly and accurately, train the machine learning model. Furthermore, focusing the training of the machine learning model on one task allows optimizing assessment of the performance of the machine learning model particularly for that task, as well as performing continuous assessment rather than punctual assessments. Furthermore, by targeting the training of the machine learning model on a specific task, it is possible to target training of the machine learning model more accurately, correct and/or fine-tune the training of the machine learning model, and thereafter significantly improve inference capabilities. Targeting the training of the machine learning model on a specific task further results in a much smaller machine learning model, with fewer trainable weights, which produces a machine learning model with less-expensive computational needs, and thus a machine learning model adapted to executed using smaller and/or fewer processor(s). The present method achieves the training of the machine learning model into the task-specific model by progressively adding labels in an initial data set and verifying and correcting the labels added in the initial data set. The present method further automatically and progressively evaluates the performances of the training of the machine learning model.

The present method starts with defining a baseline. The baseline provides the initial framework from which the machine learning model is to be trained. Creating the baseline starts by providing or defining (100) a list of information elements relating to a task. The task to be performed by the trained machine learning model could, for example, consists of generating Key Performance Index(es) and/or following up progress in relation to the generated Key Performance Index(es). The list of information elements may include one or many of the following: a topic, an entity, a sentiment, a slice of a model (i.e. a cell and important information associated with the cell or its content, name of a row, a formula used in a row, or any other type of information element pertaining to the task. Providing or defining (100) the list of information elements may be performed by a human, by a LLM, or extracted by a processor from documents, spreadsheets or from databases. The list of information elements is used by the computer for prompting the LLM to generate definitions and manifestations (110) for the information elements, in the context of the task. The list of information elements, the definitions and the manifestations is inputted by the computer in the machine learning model as structured learning parameters. The baseline is further used for by the computer for prompting the LLM to generate a test data set for evaluating the training of the machine learning model.

The method pursues in two concurrent paths: a training path and a testing path. The training path is adapted for training the machine learning model into the task-specific model, while the testing path is adapted for generating a test data set to be used for evaluating performance of the task-specific model. The training path includes labelling an initial data set to be used by the machine learning model, and/or improving labels of the information elements in relation to the task. The testing path prompts the LLM to generate examples for the information elements based on the definitions and manifestations, to generate the test data set to be used to evaluate the progress of the training of the machine learning model into the task-specific model. Providing a separate testing path further helps in creating an independent test data set, which prevents “leaking”, e.g. overfitting training of the machine learning model to the initial data set. The present method thus concurrently trains the machine learning model into the task-specific model while generating the test data set for evaluating the progress of the training of the machine learning model into the task-specific model.

The first path comprises at least one training module, and may combine multiple training modules, of which four are shown on FIG. 1. The illustrated training modules include: a labelling module 120, a semantic search augmentation module 130, a parapraphrasing augmentation module 135 and an adversarial augmentation loop module 140. Each of the training modules progressively improve the data set used by the machine learning model. Although the present specification describes the training modules 120, 130, 135 and 140 as being subsequently performed, the present method is not limited to such an implementation. For example, the method may include performing only the labelling module 120 and the adversarial augmentation loop module 140 on the training path, or consecutively performing, three or all four of the training modules on the training path. The order of the training modules 120, 130, 135 and 140 may vary and be modified depending on the task-specific model being generated.

For simplicity purposes, the data set outputted by each of the training modules 120, 130, 135 and 140 is herein referred respectively and specifically as a labelled data set, an aggregated data set, an augmented data set, and a task-specific data set. The labelled data set, the aggregated data set, the augmented data set, and the task-specific data set are training data sets at various progress levels of the training path.

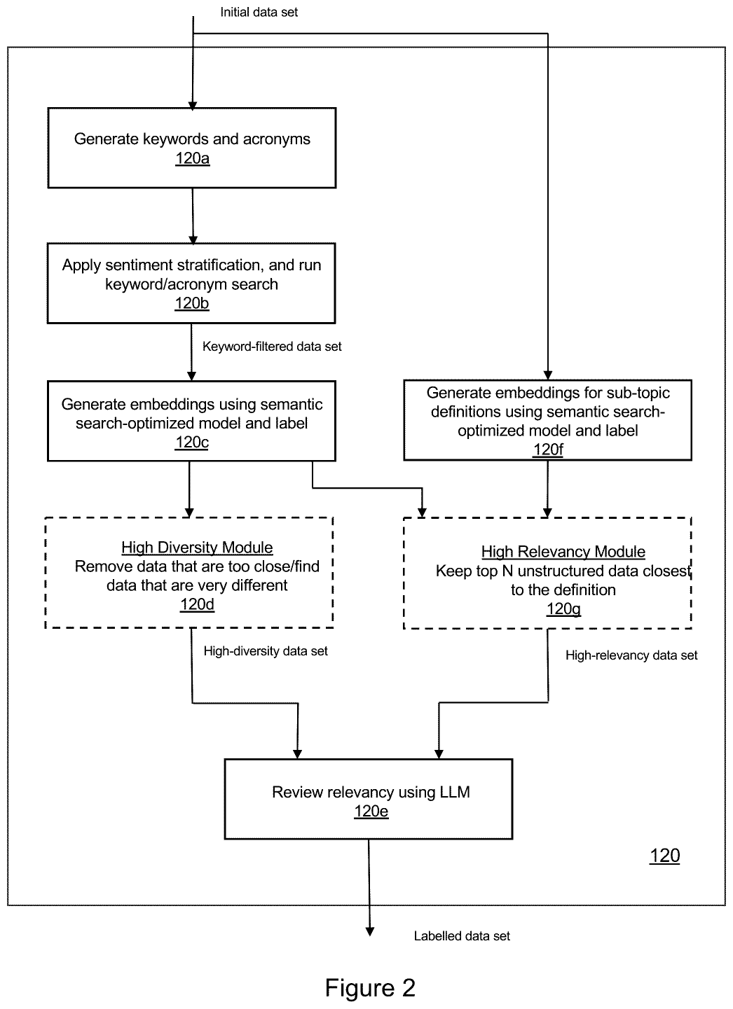

The training path begins with the labelling module 120. The labelling module 120 starts by the computer receiving the initial data set. The labelling module 120 comprises a high diversity path (left hand-side of FIG. 2) and a high relevancy path (right-hand side of FIG. 2).

The high diversity path of the labelling module 120 starts by prompting the LLM or a semantic search optimization model (not shown) to generate keyword(s) and/or acronym(s) (120a) for the information elements in the context of the task and/or for the definitions and manifestations generated in step 110. Alternatively, the computer may prompt the LLM to generate keyword(s) and/or acronym(s) for the information elements in the context of the task independently. In another alternative, the computer may prompt the LLM to generate keyword(s) and/or acronym(s) for subsets or groups of information elements concurrently, in the context of the task. In yet another alternative, the computer may prompt the LLM to generate the keywords and the acronyms for the definitions and manifestations.

The high diversity path of the labelling module 120 may further continue with stratifying the data of the initial data set using a sentiment model. Sentiment models are known in the art. The labelling module 120 performs a search (120b) for the keyword(s) and/or the acronym(s) generated in step (120a) in the initial data set. The initial data set is filtered down by keeping only data containing at least one of the keywords and/or acronyms from step 120a in the initial data set. The filtered down data is outputted as keyword-filtered data set. The keyword-filtered data set contains data that are more likely to be relevant to the specific task. The labelling module 120 further generates embeddings (120c) added to the filtered data of the initial data set. The embeddings may include for example the keyword(s) and acronym(s) generated in step 120a using a semantic search optimized model and labels the keyword-filtered data set with the generated embeddings to output a high-diversity data set. The high diversity path may further include a high diversity module (120d). The high diversity module removes data from the keyword-filtered data set to ensure the keyword-filtered data set includes data that is very different.

Alternatively to the high diversity path, or concurrently with the high diversity path, the labelling module 120 may proceed with generating embeddings for sub-topic definitions and/or manifestations directly in the initial data set using the semantic search optimization model in step 120f. The embeddings generated for the sub-topic definitions and/or manifestations are embedded into the initial data set to generate a high-relevancy data set. The high relevancy path may further include a high relevancy module (120g) for reviewing the embedded labels generated in (120f) and keeping only a predetermined number N of data set (or data documents) closest to the sub-topic definition.

The labelling module 120 continues by reviewing (120e), by the LLM, relevancy of the high-diversity data set and/or the high-relevancy data set. The LLM determines the data that is relevant, and keeps the relevant data from the high-diversity data set and the high-relevancy data set and generates therefrom the labelled data set. The labelled data set is inputted by the computer into the semantic search augmentation module 130 or used directly as input to the paraphrasing module 135 or alternatively inputted directly into the adversarial augmentation loop module 140.

The semantic search augmentation module 130 adds more training examples to the labelled data set and broadens the diversity of words in the labelled data set, by training for example a Bidirectional Encoder Representations from Transformers (BERT) model using for example a Setfit/Siamese approach (130a). The BERT model can be trained using the labeled data set as training data, or the previously trained BERT model (130b) may be used. The BERT model is used to find more data (130c) in the initial data set and/or the labelled data set for each sub-topic and generate embeddings therefor. Alternatively, both the BERT model and an Out Of The Box (OOTB) BERT model may be used to find more data (130c) in the initial data set and/or the labelled data set and generate embeddings therefor. The semantic search augmentation module 130 continues with reviewing relevancy (130d) of the additional data identified in step 130c, and the semantic search augmentation module finishes by merging (130e) the additional data to the labelled data set thereby generating the aggregated data set.

The aggregated data set is used as input to the paraphrasing augmentation module 135. The paraphrasing augmentation module 135 creates variations for the aggregated data set, e.g., variations to the aggregated data set and balancing the aggregated data set, using paraphrasing functionalities. More particularly, balancing the aggregated dataset refers to balancing a distribution of the labels embedded to prevent over representation and under representation of certain labels in a resulting augmented data set.

The augmented data set is used as an input into the adversarial augmentation loop module 140. In the event that the method goes directly from the labelling module 120 to the adversarial augmentation loop module 140, the labelled data set may be directly inputted into the adversarial augmentation loop module 140. The adversarial augmentation loop module 140 comprises a false hit correction loop sub-module 140a, an inference module 140b and a themes generation sub-module 140c. The adversarial augmentation loop module 140 may consecutively execute both the false hit correction loop sub-module 140a and the themes generation sub-module 140, in this order or in reverse order. Furthermore, the adversarial augmentation loop module 140 may execute only one of: the false hit correction loop sub-module 140a, the inference running 140b or the themes generation sub-module 140c.

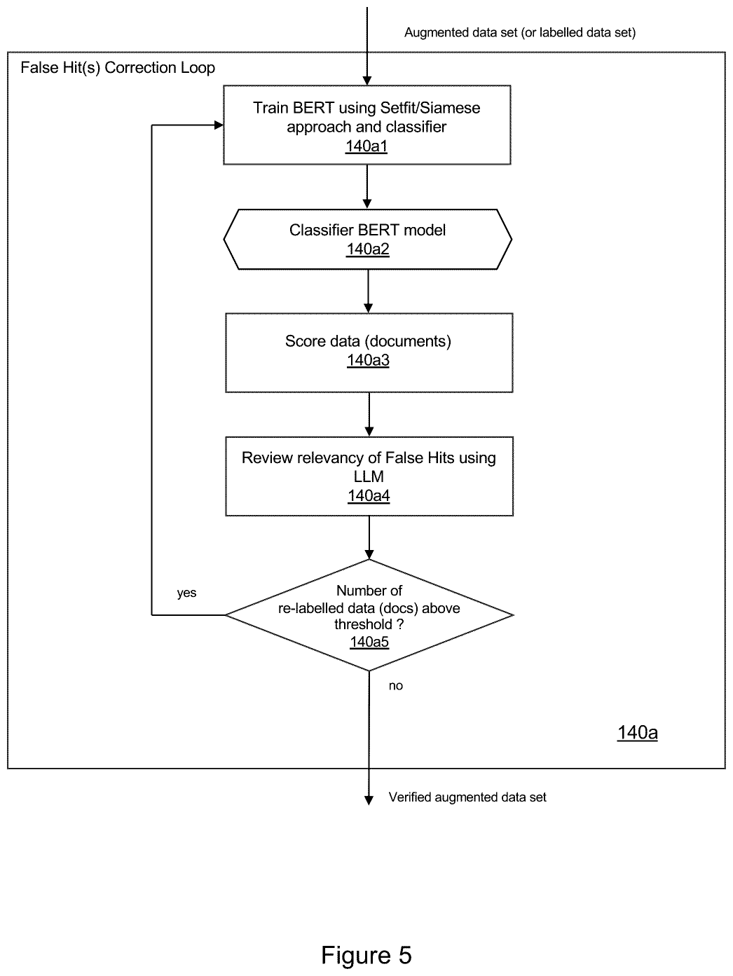

The false-hit(s) correction loop module 140a is shown in more details on FIG. 5. The false-hit correction loop module 140a includes further training (140a1) the BERT model previously discussed. The training (140a1) of the BERT model relies on a Setfit or Siamese approach and the use of classifiers. Setfit and Siamese approaches are well known in the field of Machine Learning, as well as the use of classifiers. Once the BERT model has been trained (140a1), the trained BERT model is used to classify the augmented data set. The BERT model classifies (140a2) the labels of the augmented data set (or the labelled data set in absence of the semantic search augmentation module 130 and the paraphrasing module 135) and the labels classified by the BERT model are then scored (140a3) to identify labels that are potentially false. The false hit(s) correction loop 140a continues by reviewing relevancy of the false hit(s) by the LLM (140a4). The number of data (documents) to be re-labelled in the augmented data set (or the labelled data set in absence of the semantic search augmentation module 130 and the paraphrasing module 135) is counted and if the number of data to be re-labelled is above a threshold (140a5) the false hit correction loop 140a is repeated, and if the number of data (documents) to be re-labelled is below the threshold the false hit correction loop is stopped and the adversarial augmentation loop 140 continues by running inference by the trained machine learning model (140b) on a different data set (also known as unseen data in machine learning training). This step focuses the assistance of the LLM to improving the augmented data set in an efficient and cost-effective manner. The false hit correction loop (140a) continues thereafter with the themes generation module (140c).

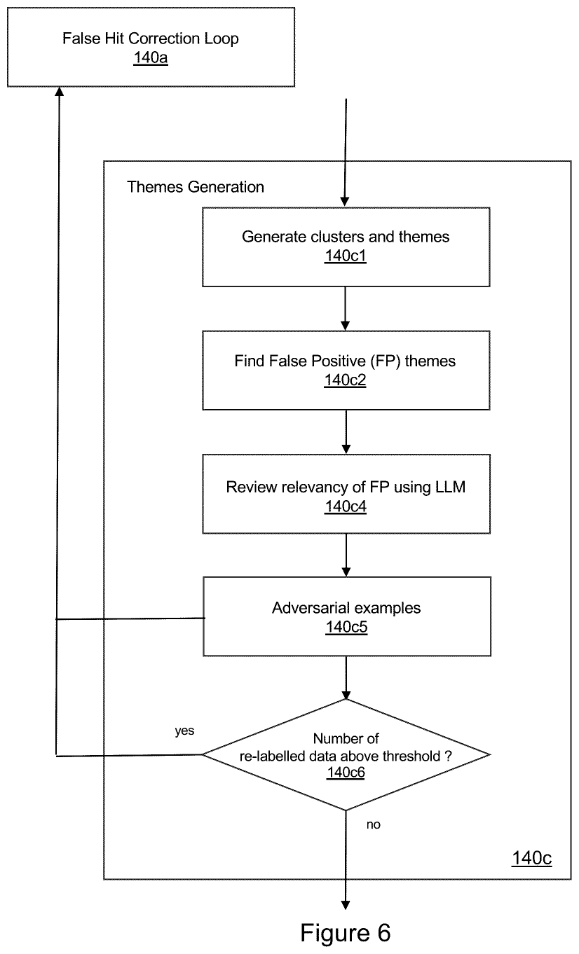

The themes generation module (140c) is shown on FIG. 6. The themes generation module (140c) starts with generating clusters for topic(s), using the embeddings inferred (140b) for the different data set, and prompting the LLM to generate themes (14001). In the context of the present specification, themes are clusters of data that are semantically similar within a broader topic, and characterized by a title (e.g. a few words) and a short description. The themes generated (140c1) are then classified by the LLM to find False Positive themes (140c2). The themes generation module 140c pursues with reviewing relevancy of the data identified as potential false positive themes (140c3) by the LLM. The themes generation module 140c then sends (140c4) the data identified as the potential false positive themes (also called adversarial examples) to the adversarial augmentation loop module 140 as additional training inputs to the false hit correction loop 140a. The number of re-labelled data from the relevancy of potential false positives (140c3) is calculated, and if the number of re-labelled data is above a threshold, the adversarial augmentation loop module 40 is repeated, and if the number of re-labelled data is below a threshold, the themes generation module 140c is ended.

Going back to FIG. 1, the testing path prompts the LLM to generate (210) the test data set, e.g. examples of data including, referring, or directed to at least one of: the information element(s), the task, the definition(s) and/or the manifestation(s). Creating the test data set from the list of elements, the definitions, and the examples of manifestations in the context of the task provides a solid base line for evaluating the training progress of the machine learning model into the task-specific model.

The method continues with evaluating performance (300) of the machine learning model as a task-specific model by using the machine learning model trained with the task-specific data set, to analyze/predict the test data set as input data. The evaluation 300 generates performance results in the form of numeric values for an array of statistical evaluation metrics, such as, but not limited to, precision, recall, f1 score, area under a precision-recall curve, etc. The performance results confirm whether the training of the machine learning model into the task-specific model is completed, or whether further training is required.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for training a machine learning model into a task-specific model, the method comprising steps of:
receiving, by a computer, a list of information elements relating to a task;
prompting, by the computer, a Large Language Model (LLM) to generate definitions and manifestations for the information elements in the context of the task;
prompting, by the computer, the LLM to generate a test data set for the information elements, the definitions and the manifestations in the context of the task;
inputting, by the computer the task, the list of information elements, the definitions and the manifestations in the machine learning model as structured learning parameters;
labelling, by the machine learning model, an initial data set, by:
prompting by the computer the LLM to generate keywords and acronyms for the list of information elements in the context of the task, keyword and/or acronym to generate a keyword-filtered data set;
search by the computer the initial data set for the keywords and acronyms and generate therefrom a keyword-filtered data set; and
prompting, by the computer, the LLM to label the keyword-filtered data set by generating embeddings by means of a semantic-search optimized model for the keyword-filtered data set using at least one of: the information elements, the definitions, and the manifestations to produce a labelled data set;
performing, by the computer, an adversarial augmentation loop on the labelled data set, the adversarial augmentation loop: identifying improper embeddings in the labelled data set, re-labelling the improper labels in the labelled data set and generating a task-specific data set; and
evaluating, by the computer, performance of the machine learning model trained with the task-specific data set by instructing the machine learning model to classify the test data set, and if results of the classifying by the machine learning model trained with the task-specific data set of the test data set is above a threshold, the training of machine learning model into the task-specific model is completed.

2. The method of claim 1, wherein the list of information elements includes at least one of: a topic, a subject, a sentiment and an entity.

3. The method of claim 1, wherein labelling of the initial data set comprises:
performing a high diversity review of the embeddings of the keyword-filtered data set;
performing a high relevancy review of the embeddings of the keyword-filtered data set; and
prompting the LLM to review the relevancy of the highly diverse and highly relevant embeddings in the context of the task.

4. The method of claim 1 wherein the adversarial augmentation loop is repeated until a number of adversarial examples identified in the labeled data set is above a threshold.

5. The method of claim 4, further comprising:
executing by the computer a semantic search optimized model to generate at least one semantically optimized information element that is not captured by the keyword or acronym search; and
inputting, by the computer, in the machine learning model the semantically optimized information element as structured learning parameters for labelling the filtered data set.

6. The method of claim 3, further comprising:
prompting the LLM to review relevancy of the combination of the high diversity data set and the high relevancy data set; and
combining the high diversity data set and the high relevancy data set into the labelled data set.

7. The method claim 1, further comprising before evaluating performance of the machine learning model:
applying the labelled data set to train a machine learning Bidirectional Encoder Representations from Transformers (BERT) model and to use the trained BERT model for generating an augmented data set, using any of the definitions, the keywords, the acronyms, the labelled data set in the context of the task; and
merging the augmented data set and the labelled data set into an aggregated data set to be used as input by the adversarial augmentation loop instead of the labelled data set.

8. The method of claim 7, further comprising before evaluating performance of the machine learning model:
creating variations of the embeddings of in the aggregated data set and generating thereby an augmented data set.

9. The method of claim 1, further comprising, before evaluating performance of the machine learning model, balancing a distribution of embeddings and generating thereby an augmented data set.

10. The method of claim 1, wherein the adversarial augmentation loop comprises executing:
a false hit correction loop; and
a theme generation module.

11. The method of claim 10, wherein the false hit correction loop comprises:
scoring the documents of any of the labelled data set, the aggregated data set and the augmented data set using the BERT model, the scoring including a prediction score, associating a scoring to each document to generate a scored data set;
prompting the LLM to review relevancy of the documents of the scored data set with the prediction score;
correct the embeddings of the scored data set with the prediction score and repeat the false hit correction loop until the number of re-labelled data is below a false hit threshold.

12. The method of claim 10, wherein the themes generation module comprises:
generate clusters and themes for the different data set;
find False Positive theme generated for the different data set;
review relevancy of the False Positive themes generated for the different data set; and
generate adversarial examples from the reviewed False Positive themes.

13. A computer for performing the method of claim 1.
